(19) United States
(12) Patent Application Publication
(10) Pub. No.: US 2016/0332411 A1
(43) Pub. Date: Nov. 17, 2016

(54) PANEL ELEMENT MADE OF WOOD

(71) Applicant: Gerhard WEISSTEINER, Vintl/Pfunders (IT)

(72) Inventor: Gerhard WEISSTEINER, Vintl/Pfunders (IT)

(21) Appl. No.: 14/902,090

(22) PCT Filed: Jun. 24, 2014
(86) PCT No.: PCT/EP2014/063288

§ 371 Date: Dec. 30, 2015

(30) Foreign Application Priority Data
Jul. 2, 2013 (EP) 13174730.5

(51) Int. Cl. B32B 3/14; E04C 2/14; E04B 2/00; B27M 3/00; B32B 3/30; B32B 7/00; B32B 7/08; B32B 21/13; E04C 2/34; E04B 5/02

(52) U.S. Cl. CPC B32B 3/14; E04C 2/34; E04C 2/14; E04C 2/46; E04C 2/50; B32B 3/30; B32B 7/005; B32B 7/08; B32B 21/13; B27M 3/0066; B27M 3/0026; B32B 2307/546; B32B 2307/734; B32B 2419/00; B32B 2607/00

(57) ABSTRACT

The invention relates to a panel element (1) made of wood, consisting of at least two layers (3, 4), each of which is made of boards (2) lying adjacently to one another in a parallel manner. A board (2) of the first layer (3) and a board (2) of the second layer (4) are connected to each other by dovetail joints, and the dovetail joints are produced by a sequence of dovetail-shaped recesses (11) and projections (12), said recesses and projections following one another in the direction of the longitudinal extension of the boards (2) and being shaped into the boards (2). A board (2) of the first layer (3) and a board (2) of the second layer (4) are offset relative to each other and overlap each other in the direction of the width (10), and the recesses (11) of the dovetail joints have a wedge shape so as to taper from a board edge (13) to a board center (14).

The invention concerns a panel element made of wood, and/or a beam made of wood, in accordance with the features in the preamble of claims 1 and 15.

One of the many uses of wood as a material is that for the construction of buildings as a building material, for example in traditional forms of building such as the log cabin style. As conditioned by an increasing demand for wood as a building material, however, the latter is also gaining increasing importance in prefabricated house construction, and in the construction of new buildings. Here larger prefabricated wall elements are in particular coming into use to some extent. In addition to use as wall elements, such panel-form elements made of wood can also be deployed in the manufacture of floors and ceilings. In addition to wall elements made of wood, however ties made of laminated wood, also designated as gluelams, are also of importance; these can be used as uprights or as load-bearing components for roof trusses.

By virtue of an increasing level of health awareness in large parts of the population, and a thus hoped for improvement in living standards, the question of the elimination of additives, such as, for example, glue for joining the wooden parts is attracting more and more interest in the manufacture of such panel elements made of wood.

From the prior art wall elements of buildings, such as are described in the documents EP 1 734 200 B1 and EP 2 060 694 B1, are already of known art. The document EP 1 734 200 B1 describes a wall element of a building in the form of a composite panel of wood plies with at least two plies of timbers, in each case arranged adjacently to one another in layers. The two plies are connected with one another by means of grooves located opposite one another and therein-inserted dovetail battens. The document BE 503 355, on the other hand, describes a component made of a plurality of timbers oriented in parallel connected so as to form an element. For purpose of connecting the timbers to one another projections and depressions are formed along their lengthwise extent in lengthwise sides facing each other. The cross-section of the projections and depressions is shaped in the manner of a dovetail joint, and the timbers, or wooden parts, are accordingly joined together in a form-fit manner.

The object of the invention is to specify a panel element made of wood, and/or a beam made of wood, which can be used as a structural part in the construction of buildings.

The object of the invention is achieved by means of a panel element made of wood, consisting of at least two layers of boards, arranged in each case lying adjacently to one another in a parallel manner, wherein the boards of a first layer are oriented parallel to boards of a second layer, and wherein a board of the first layer and a board of the second layer are connected with one another by means of dovetail joints, and the dovetail joints are formed by means of a sequence of dovetail-shaped recesses and projections following one another in the direction of a lengthwise extent of the boards, and are shaped in the boards. Here the recesses and projections extend in the direction of a width of the boards, wherein a board of the first layer and a board of the second layer are arranged to be offset relative to each other in the direction of the width and to overlap each other, and the recesses of the dovetail joints have a wedge shape so as to taper from a board edge to a board centre. This has the advantage that in the manufacture of the panel element the boards can be joined together so as to lie close to one another on their contact surfaces. As a consequence a high thermal insulation effect is also achieved in the panel element manufactured in this manner. Moreover, the panel element designed in this manner also has a high internal stiffness and dimensional stability.

By providing the recesses of the dovetail joints on both sides with an inclined position, with a half wedge angle with a value of between 0.5° and 10°, preferably of between 3° and 10°, a simplification of the assembly of the boards to form the panel element is achieved, at the same time with high internal strength and stability.

The design of the panel element, whereby a board of the first layer and a board of the second layer overlap each other over an overlapping width having a value that is equal to or greater than 10% of the board width, has the advantage of an increased dimensional stability for the structure of the panel element formed by the boards.

In accordance with a further development of the panel element provision is made for the dimensions of the projections to be selected in proportion to the dimensions of the recesses such that boards of one respective layer lie against one another so as to be gap-free. This has the advantage of an increased thermal insulation effect of the panel element, in that the effective thickness of the panel element is correspondingly greater.

By ensuring that in the panel element the value of the overlapping width corresponds to approximately one half of the width of the boards, and a tongue-and-groove joint is designed between boards lying adjacent to one another and within one layer, both the insulating, that is to say, heat blocking, effect of the panel element is improved, and also a reinforcement of the joint between the boards is achieved, in that an additional force-fit connection effect is achieved by means of the tongue-and-groove joint.

A further development of the panel element, whereby the projections and the recesses of the boards are symmetrically disposed with respect to a centre plane at right angles to the width of the boards, has the advantage that by this means the manufacture of a system of uniformly shaped boards is enabled. Uniformly shaped boards of the same basic shape can thus be assembled together in a modular manner to form panel elements.

Provision can furthermore be made for the dimensions of the recesses to be calculated such that a clear width at the edge of the board equals a width of the projection in the region of the centre plane. By this means it is advantageously achieved that the boards can be arranged so as to lie close to one another, thus filling the space.

In accordance with a variant of embodiment of the panel element, provision can also be made for a beam to be arranged in a first end region with respect to a lengthwise axis of the boards, and for the said beam to be oriented at right angles with respect to the boards. By this means an increase in the rigidity of the shape of the panel element is advantageously achieved.

Furthermore, by arranging the beam to be located between the first layer and a third layer made of boards, that is to say, such that the beam has a thickness, the value of which is equal to a value of the thickness of the boards, a standardised configuration of the end regions of the boards is enabled.

[In accordance with a further development of the panel element, provision can also be made for a beam to be accommodated in a region distant from the two end regions, which beam is oriented so as to be parallel with the beam located in the first end region, and is disposed between the layers. Thereby, and by means of the measure whereby the boards and the beam are fixed to one another by bolts that pass through the boards and the beam, an even greater rigidity of the shape of the panel element is achieved.

By forming depressions in the projections of the boards for the purpose of forming cavities in the panel element, the formation of air-filled cavities in the panel element is enabled; these advantageously effect an increase in the thermal insulation properties of the panel elements.

[In accordance with a further development provision is moreover made for grooves to be formed in the projections. This allows a simpler manufacture of the depressions for the purpose of forming cavities.

In accordance with a variant of embodiment of the panel element provision is made for additional wooden cladding to be arranged on one of the layers made of boards, wherein the wooden cladding comprises a layer of boards lying adjacently to one another in a parallel manner. This has the advantage of a greater variety in the selection of configurational options for the surfaces of the panel elements.

For a better understanding of the invention the latter is described in more detail with the aid of the following figures.

Here, in each case in a highly schematic simplified representation:

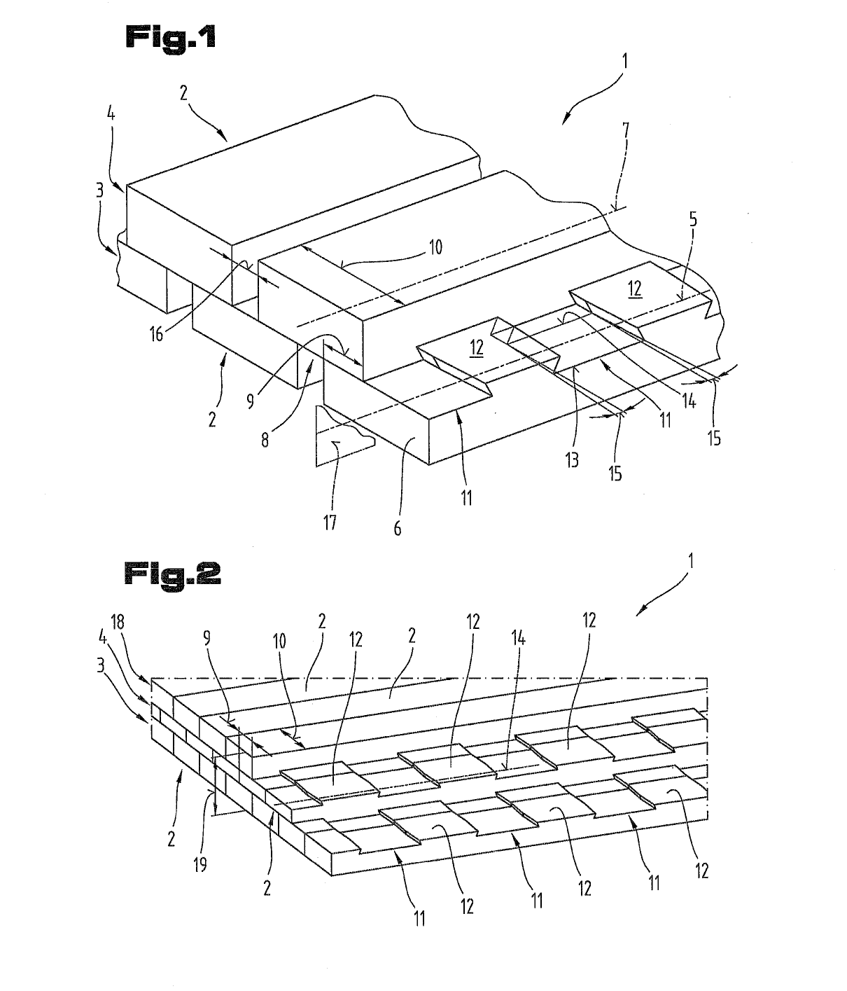

FIG. 1 shows a panel element consisting of a plurality of boards, or wooden parts;

FIG. 2 shows a panel element with boards arranged in three plies, or layers;

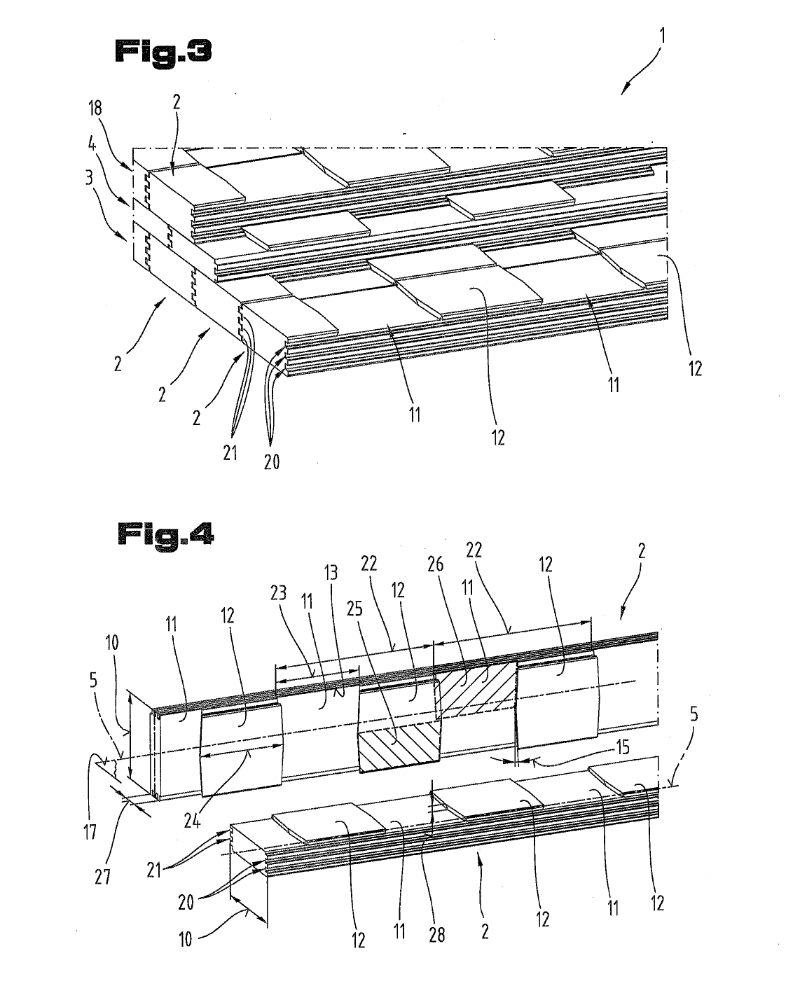

FIG. 3 shows a panel element made of boards, which have expansion joints;

FIG. 4 shows a board for use in the panel element as in FIG. 3;

FIG. 5 shows a further example of embodiment of the panel element with a total of five layers of boards;

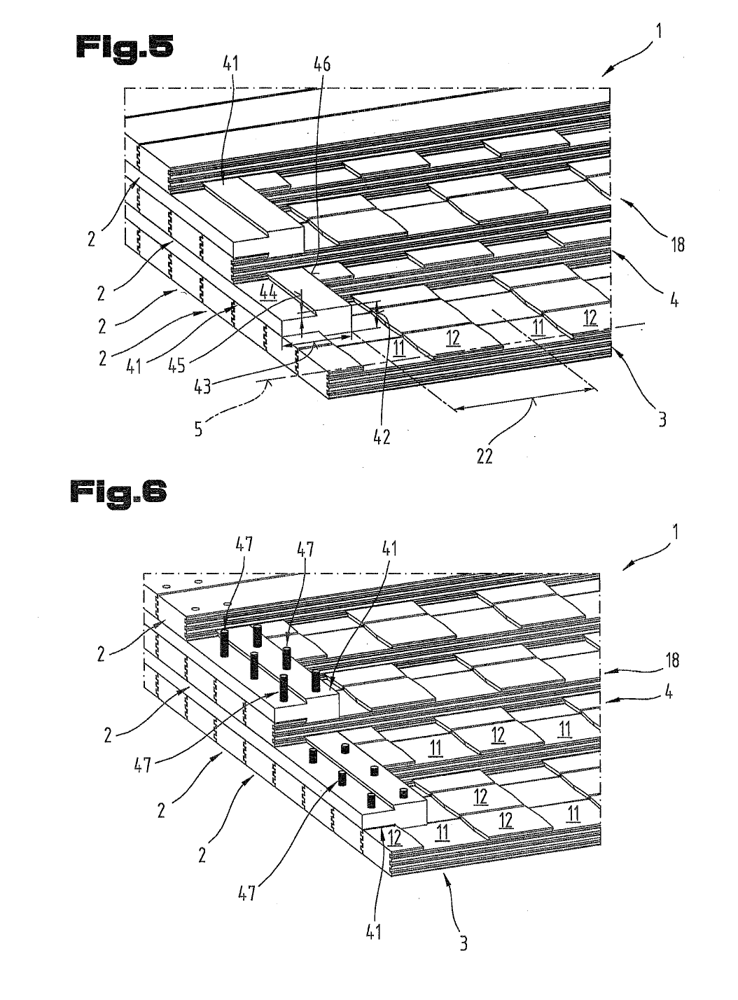

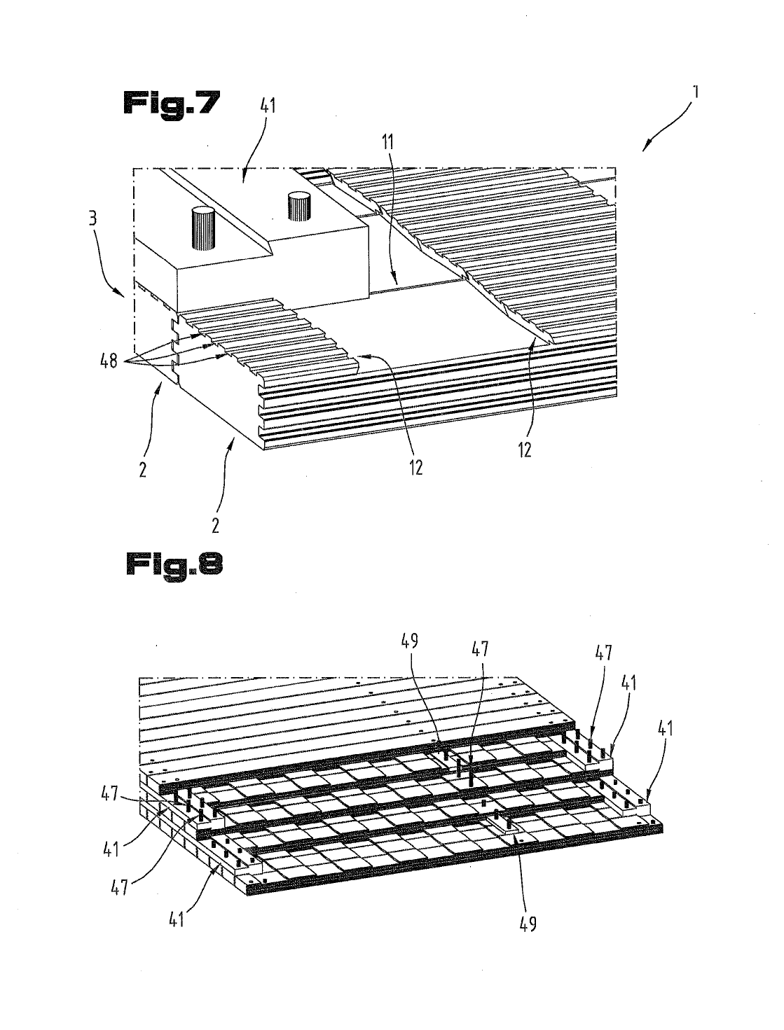

FIG. 6 shows a variant of embodiment of the panel element as in FIG. 5;

FIG. 7 shows a variant of embodiment of the panel element as in FIG. 6;

FIG. 8 shows a panel element as in FIG. 6 with beams lying transversely;

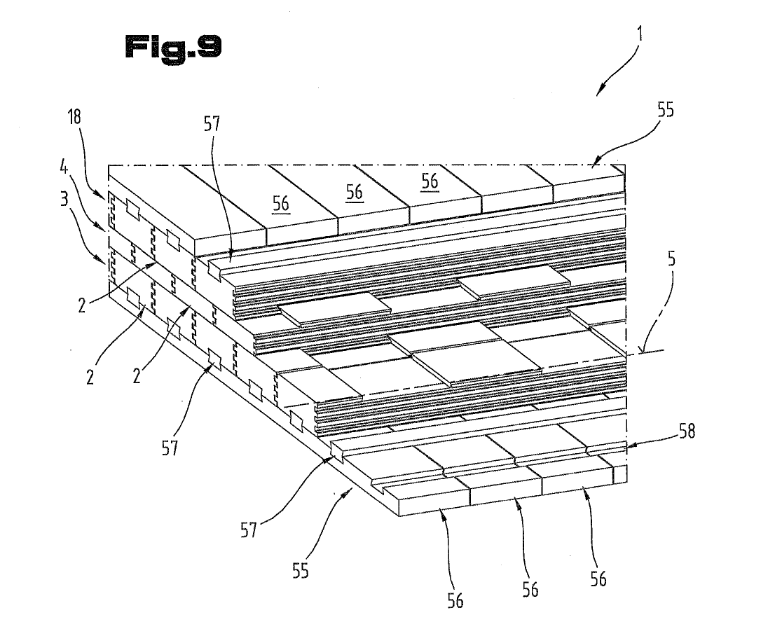

FIG. 9 shows a further example of embodiment of the panel element with additional wooden cladding;

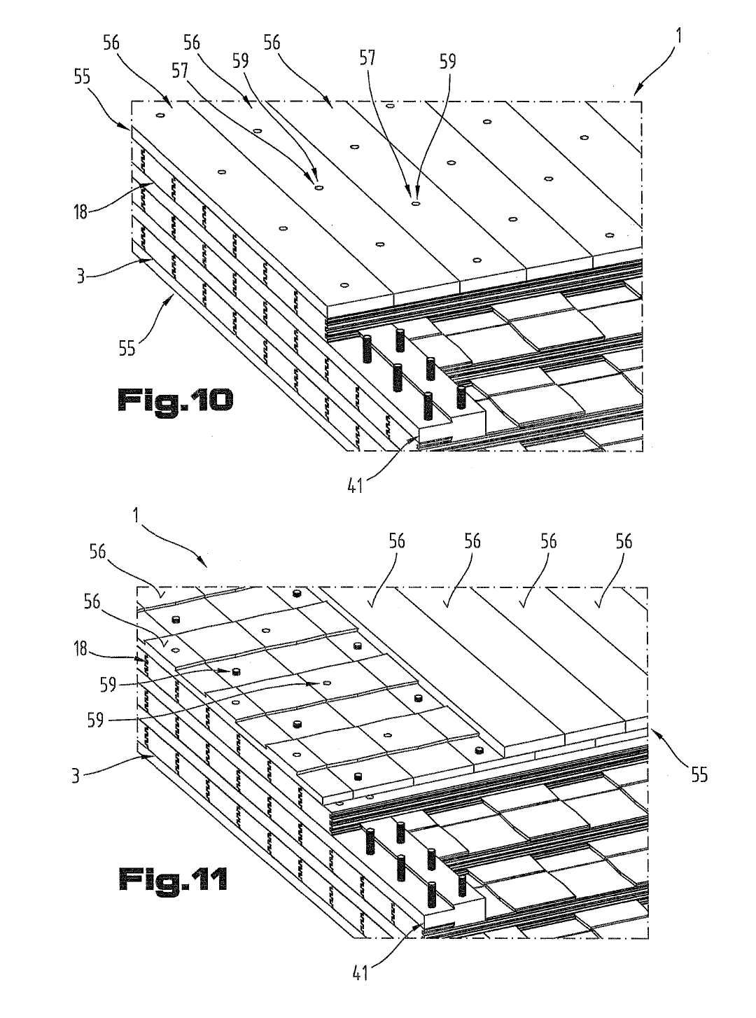

FIG. 10 shows an example of embodiment of the panel element as in FIG. 8 with alternative wooden cladding;

FIG. 11 shows a panel element with two-ply wooden cladding;

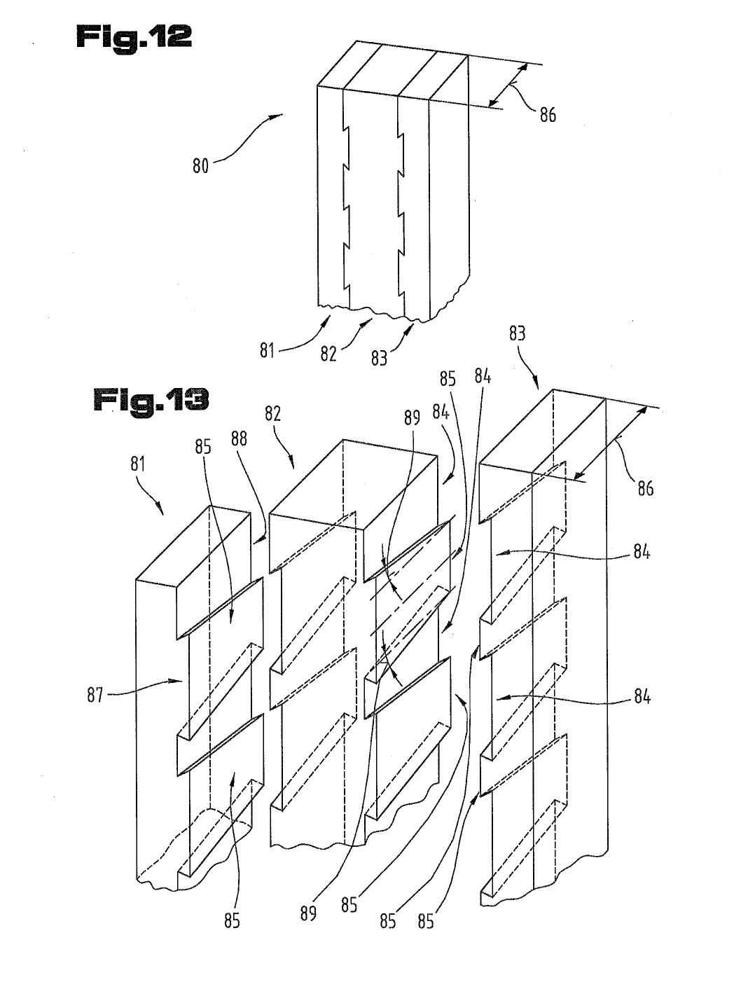

FIG. 12 shows a beam composed of a plurality of layers;

FIG. 13 shows the boards of the beam as in FIG. 12 in a disassembled state.

By way of introduction it should be noted that in the various forms of embodiment described the same parts are provided with the same reference symbols, and/or the same component designations, wherein the disclosures contained in the whole description analogously can be transferred to the same parts with the same reference symbols, and/or the same component designations. Also the location details selected in the description, such as e.g. above, below, at the side, etc are referred to the immediately described and represented figure, and in the event of an alteration of location are to be transferred analogously to the new location. Furthermore individual features or combinations of features from the various examples of embodiment shown and described can also represent in their own right independent inventive solutions, or solutions in accordance with the invention.

All details regarding ranges of values in the representational description are to be understood to mean that these include any and all sub-ranges of the latter, e.g. the statement 1 to 10 is to be understood to include all sub-ranges, starting from the lower limit 1 and the upper limit 10, i.e. all sub-ranges begin with a lower limit of 1 or more, and end with an upper limit of 10 or less, e.g. 1 to 1.7, or 3.2 to 8.1, or 5.5 to 10.

FIG. 1 shows a panel element, which is formed by the connection of a plurality of boards 2, or wooden parts. In accordance with this example of embodiment the panel element 1 comprises a first layer 3 of boards 2 arranged in each case lying adjacently to one another in a parallel manner, and a second layer 4, also with boards 2 arranged adjacently to one another in a parallel manner. Here moreover, a lengthwise extent, or more particularly, a lengthwise axis 5 of a first board 6 of the first layer 3, and a lengthwise extent, or more particularly, a lengthwise axis 7 of a board 8 of the second layer 4, are oriented parallel to one another. Finally, the boards 2 of the second layer 4 are also arranged offset in the lateral direction relative to the boards 2 of the first layer 3. Thus the board 6 of the first layer 3 and the board 8 of the second layer 4, as also the other boards 2 respectively, have in each case an overlapping width 9. The value of the overlapping width 9 corresponds in the example of embodiment represented to approx. ⅓ of a width 10 of the boards 2. A value is selected for the said overlapping width 9 that is preferably equal to, or greater than, 10% of the width 10 of the boards 2.

The connection of the individual boards 2 to form an overall rigid shape of panel element 1 is achieved by providing a form-fit joint between boards 2, 6, 8 in the regions of the overlapping width 9. This joint is preferably designed in the manner of a dovetail joint. The functionality of this joint can be explained on the basis of the region represented on the right below in FIG. 1 with the two boards 6 and 8. On its side facing towards the second layer 4 the board 6 has a sequence of recesses 11, which follow one another in the direction of the lengthwise axis 5 of the board 6. At the same time these recesses 11 run essentially at right angles to the lengthwise axis 5, that is to say, the lengthwise extent, of the board 6 and extend from edge to edge over the whole width 10 of the board 6. The profile of such a recess 11 is thereby configured in the form of a dovetail, so that overall a sequence of dovetail-shaped recesses 11 and projections 12 ensues along the lengthwise extent, that is to say, the lengthwise axis 5.

In the board 8 of the second (upper) layer 4, on the other hand, provision is made for its side facing the first (lower) layer 3 to have a complementary configuration to the recesses 11 and projections 12 of the board 6 of the lower layer 3. In the state in which they are joined together, projections 12 of the board 6 therefore engage in recesses 11 of the board 8, and vice versa.

The assembly of the boards 2, 6, 8 to form the panel element 1 can thus take place such that projections 12 and recesses 11 of the first board 6 and the second board 8 are oriented such that they are aligned with one another, and the two boards 6, 8 are moved one upon another in the direction of the width 10, and finally these are joined with one another by the insertion of the recesses 11 and the projections 12 into one another.

In accordance with this example of embodiment provision is also made for the cross-section of the recess 11 not to be constant over the width 10; instead it is variable. In actual fact the recess 11 is formed in the shape of a wedge so as to taper from a board edge 13 to a board centre 14. Thus on both sides the recesses 11 have an inclined position with a half wedge angle 15. The projections 12 and the recesses 11 of the boards 2 are moreover symmetrical with respect to a centre plane 17 at right angles to the width 10 and containing the board centre 14. The value of the half wedge angle 15 is preferably selected from a range between 1.5° and 10°, preferably between 3° and 10°.

In the example of embodiment of the panel element 1 as in FIG. 1 the dimensions of the projection 12 on the board 6 are selected in proportion to the dimensions of the recess 11 on the board 8 such that a gap 16 remains free between boards 2 of the same layer, 3 or 4. This occurs because the widening of the projection 12 on the board 6 is somewhat greater than the corresponding widening of the recess 11 on the board 8. The two boards 6 and 8 can thus not be completely inserted into one another as far as the board centre 14. The overlapping width 9 is therefore also less than the half width 10 of the boards 2.

FIG. 2 shows a panel element 1 with boards 2 arranged in three plies or layers. In addition to the first layer 3 and the second layer 4, the panel element 1 in accordance with this example of embodiment features a third layer 18 with boards 2 that are also arranged adjacently to one another in a parallel manner. In the same manner as between the boards 2 of the first layer 3 and the boards 2 of the second layer 4, a form-fit joint is also formed between the boards 2 of the second layer 4 and the boards 2 of the third layer 18. To this end the boards 2 of the second layer 4 now also have on their side facing towards the third layer 18 a regular sequence of recesses 11 and projections 12. At the same time the boards 2 of the third layer 18 have corresponding recesses 11 and projections 12 on their side facing the second layer 4. The profile of the recesses with respect to a direction parallel to the width 10 of the boards 2 is configured in the manner of a dovetail joint, wherein the cross-section has a profile tapering in the form of a wedge towards the board centre 14. In the panel element 1 in accordance with this example of embodiment the dimensions of the projections 12 are selected in proportion to the dimensions of the recesses 11 such that the boards 2 of each layer 3, 4, 18 lie against one another so as to be gap-free. The overlapping width 9 between boards 2 of layers 3, 4, 18 located opposite one another thus corresponds to exactly half the width 10 of the boards 2. By virtue of the fact that the boards 2 in the panel element 1 in accordance with this example of embodiment lie close against one another so as to be gap-free, the panel element 1 forms overall an essentially solid body with a thickness 19 that corresponds to approx. three plies of boards 2. When using the panel element 2 as a wall element, for example when constructing a building, this has the advantage of a correspondingly greater insulation effect corresponding to the greater thickness 19, when compared for example, to the panel element 1 in accordance with the example of embodiment in FIG. 1, in which, on account of the gaps 16, the insulation effect of the wall thickness is significantly less.

FIG. 3 shows a further form of embodiment of the panel element 1, optionally independent, wherein once again the same reference symbols and component designations are used for the same parts as in the preceding FIGS. 1, 2. In order to avoid unnecessary repetitions, reference is made to the detailed description in the preceding FIGS. 1, 2.

FIG. 3 shows a panel element 1 of boards 2, which additionally also have expansion joints. For this purpose a plurality of grooves 20 is provided on the boards 2 on the side faces of the boards 2 that are adjacent to the projections 12, i.e., that are on the narrow sides. The grooves 20 of a first side face are arranged offset relative to grooves 21 of a side face of the board 2 that is located opposite, such that two boards 2 lying adjacently to one another in a layer 3, 4, or 18 can be joined together in the manner of a tongue-and-groove joint. With respect to the joining together of the boards, with their projections 12 and recesses 11 formed in the shape of dovetails and running in the shape of wedges, this has the advantage that expansion joints are on hand. This makes it possible to push the projections 12 together with the recesses 11 using an appropriate level of effort to the extent that the static friction achieved by this means effects an overall form-fit and force-fit joint between the boards 2 so as to form the panel element 2. In addition this also allows elimination of the use of glue for the purpose of joining the boards 2 in the manufacture of the panel element 1.

FIG. 4 shows a board 2 for use in the panel element according to FIG. 3 in two different positions. In a first side (corresponding to the width 10) the dovetail-shaped recesses 11 are formed in the board 2, preferably at equal distances 22 with respect to the lengthwise axis 5, such that a regular sequence of recesses 11 and projections 12 is present.

The projections 12 and the recesses 11 are preferably formed symmetrically with respect to the centre plane 17, with a half wedge angle 15. At the same time the dimensions of the recess 11 are calculated such that a clear width 23 at the edge 13 of the board 2 equals a width 24 of the projection 12 in the region of the centre plane 17. Thus a region 25 of the projection 12 and a region 26 of the recess 11 are formed; these are indicated in FIG. 4 by hatched areas. The region 25 of the projection 12 features a sub-volume bounded by the centre plane 17, the outer shape of which corresponds essentially to a symmetrical trapezium. The said sub-volume of the region 25 at the same time forms one half of the projection 12. The region 26 of the recess 11 features at the same time one half of the recess 11 bounded by the centre plane 17. The region 26 of the recess 11 resembles the region 25 of the projection 12, inasmuch as the two regions 25, 26 have the same outer shape. Accordingly a region 25 of a projection 12 of another board 2 can be inserted into the region 26 of the recess 11 of the first board exactly, that is to say, essentially filling the space. By virtue of the dovetail-shaped cross-sections of the projections 12 and the recesses 11, a form-fit joint, as described above with respect to FIG. 3, is therefore made between the boards 2 of the panel element 1.

The design of the grooves 20 and 21 on the narrow sides of the boards 2 is configured such that projections located between the grooves 20 can be inserted as tongues into the grooves 21 of another board 2 (FIG. 3). The configuration of the boards 2 as described, with the recesses 11 and the projections 12 on the one hand, and the grooves 20 and 21 in the sides of the board 2 adjacent to the projections 12 on the other hand, advantageously enables a modular construction of panel elements 1. Boards 2 with a basic form of essentially the same shape can be assembled, as in a building block approach, to form panel elements 1 of almost any size. Thus, for the construction of the panel element 1 as represented in FIG. 3, just two basic forms or types of boards are required. For the boards 2 of the first layer 3, boards 2 as represented in FIG. 4 are on hand. If in the case of the second layer 4, another layer, that is to say, the layer 18 as in FIG. 3, is to be attached, another basic form of the boards 2 is thus required for the boards 2 of the second layer 4; this basic form on the one side has projections 12 and recesses 11, and on the wide side located opposite to the first side also has a similarly alternating sequence of projections 12 and recesses 11. In the case of the panel element 1 as in FIG. 3, a panel element 1 with a total of four layers could be manufactured by means of a further, that is to say, a fourth layer (not represented) of boards 2 as in FIG. 4. That is to say, a panel element 1 composed in this manner is essentially bounded by flat surfaces on all external sides.

The inventive boards can be manufactured on a basis of conventional boards with a rectangular outer boundary. To this end the recesses 11 and the grooves 20, 21 are formed using appropriate tools in what is initially an unmachined board with a width 10 and a thickness 27. This work can, for example, be executed using appropriate sawing and/or milling tools. Here the recesses 11 are calculated such that a value of a depth 28 lies in a range from 10% to 30% of the thickness 27 of the boards 2.

FIG. 5 shows a further example of embodiment of the panel element 1 with a total of five layers 3, 4, 18 of boards 2. This panel element 1 features a beam 41 in at least a first end region with respect to the lengthwise extent, or more particularly, the lengthwise axis 5 of the boards 2. Here it should be noted that in the representation as in FIG. 5 (as also in FIGS. 1 to 3), the individual layers 3, 4, 18 are on some occasions not shown completely, and the beams 41 are on some occasions represented in a truncated manner, for better clarification of the internal construction of the panel element 1. The said beam 41 is oriented at right angles with respect to the lengthwise axis 5 of the boards 2, and is arranged located between the first layer 3 and the third layer 18. The beam 41 has a thickness 42, the value of which is equal to the thickness 27 of a board 2. The value of a width 43 of the beam 21 is equal to half the distance 22 between successive recesses 11 arranged and formed in the boards 2. Finally, on its sides corresponding to the width 43, the beam 41 features recesses 44 with a depth 45, the value of which is equal to the depth 28 of the recesses 11 in the boards 2. The recesses 44 of the beam 41 extend in the form of a profile over the whole lengthwise extent of the beam 41. They are calculated such that the sides of the beam 41 corresponding to the width 43 and also a narrow side 46 of the beam 41 are in direct vertical contact with adjacent boards 2 of the first layer 3 and the third layer 18, and also with end faces of the boards 2 of the second layer 4. In this manner a form-fit joint is also formed between the beam 41 and the boards 2 of the panel element 1, as between the boards 2 themselves.

[As a result of the additional provision of the beam 41 in the panel element 1, an even greater rigidity is achieved for the shape of the panel element 1. Deformations, such as can occur in the case of boards made of sawn wood, as is well-known, as a consequence of an alternating moisture content as a result of drying out, or the absorption of moisture in environments with a high air humidity, can at least in part be intercepted by the mechanical strength of the beam 41, and thus prevented.

FIG. 6 shows a variant of embodiment of the panel element 1 as in FIG. 5. In addition to two beams 41, the panel element also has pins or bolts 47 passing through the boards 2 and the beams 41; these are inserted in corresponding holes oriented transverse to the panel element 1. The pins or bolts 47 can be designed as wooden dowels or wooden screws; however, they can also consist of another material, such as e.g. metal or plastic. In addition to an increase of the stiffness of the panel element 1 as a result of the bolts 47, an additional rigidity is achieved with respect to any alteration in shape that may possibly occur in the direction of the width 10 of the panel element 1. Wood is preferably used as the material for the bolts 47.

FIG. 7 shows a variant of embodiment of the panel element 1 as in FIG. 6. In this example of embodiment grooves 48 are formed in the projections 12 of the boards 2. These grooves 48 are arranged adjacently to one another in a parallel manner, and run parallel to the lengthwise axis 5 of the boards 2. The grooves 48 effect the formation of cavities enclosed between the boards 2 of the various layers 3, 4, 18. By this means air enclosed in the cavities of the grooves in turn effects an increase of the thermal insulation effect of the panel element 1.

As an alternative to the grooves 48 in the projections 12 that are oriented parallel to the lengthwise axis 5 of the boards 2, however, grooves that are otherwise oriented, or depressions that are shaped in quite another manner, can also be provided for the purpose of forming closed cavities in the panel element 1. At the same time, however, it is also possible for further depressions to be provided in the material of the board 2 in the region of the recesses 11 for the purpose of forming intermediate cavities.

FIG. 8 shows a panel element 1 as in FIG. 6 with beams 41 lying transversely. For this purpose beams 41 are arranged in the two end regions of the boards 2, as described in the context of FIG. 6. In addition to the existing form-fit joints, these beams are also additionally fixed in their positions relative to the panel element 1 by means of the bolts 47. In this example of embodiment, in addition to the beams 41 in the two end regions of the boards 2, the panel element 1 also features beams 49 in a region at a distance from the two end regions, and intermediately located between them; these beams are disposed between the layers 3, 4, 18, of the panel element 1. In a similar manner to the beams 41 of the end regions of the boards 2, these beams 49 are integrated into the panel element 1 transversely to the lengthwise axis 5 of the boards 2. The beams 49 have an essentially rectangular cross-section and for their disposition between the layers 3, 4, 18, of the boards 2 in the adjacent surfaces of the boards 2, namely in accordance with the example of embodiment in the region of the recesses 11, are provided with additional recesses that are complementary to the outer form of the beams 49. In a similar manner to the beams 41 in the two end regions of the boards 2, the beams 49 are also fixed with bolts 47.

FIG. 9 shows another example of embodiment of the panel element with additional wooden cladding 55. In its interior this panel element 1 is formed by three layers 3, 4, 18, of boards 2, in the manner described as in FIG. 3, wherein the boards 2 are joined together in a form-fit manner. On the two outer sides the wooden cladding 55 is in each case arranged as a further layer of boards 56, and is also joined in a form-fit manner with the first layer 3 and the third layer 18. To this end the boards 56 of the wooden cladding 55 are arranged transversely, that is to say, they are oriented at right angles to the lengthwise extent, or more particularly, the lengthwise axis 5 of the boards, and are arranged lying adjacently to one another in a parallel manner. The connection of the boards 56 of the wooden cladding 55 with the boards 2 of the first layer 2, and the third layer 18 respectively, is undertaken by the interposition of a plurality of connecting elements 57. In this example of embodiment the connecting elements 57 are formed as dovetail battens. These dovetail battens 57 are inserted, parallel to the lengthwise extent, or more particularly, the lengthwise axis 5 of the boards 2, into corresponding recesses in the boards 2. The boards 56 of the wooden cladding 55 for their part have similarly corresponding recesses, or more particularly, grooves 58, by means of which they can in turn be joined with the connecting element 57. As already described, the connecting elements 57 are formed as dovetail battens. That is to say, between the boards 56 and the connecting element 57 on the one hand, and the connecting elements 57 and the boards 2 on the other, a form-fit joint is formed in each case in the manner of a dovetail joint.

In an alternative variant of embodiment, however, the connecting element 57 could also be joined in the form of a tongue-and-groove joint with the boards 2 on the one hand, and the boards 56 of the wooden cladding 55 on the other. That is to say, the connecting element 57 is formed as a so-called tongue, and the wooden cladding 55 is then attached by means of a force-fit joint onto the boards 2.

FIG. 10 shows an example of embodiment of the panel element 1 as in FIG. 8 with the wooden cladding 55 in an alternative variant of embodiment. Here the boards 56 of the wooden cladding 55, lying adjacently to one another in a parallel manner, are connected by means of connecting elements 57 in the form of wooden dowels 59 or wooden screws, in each case with the outer layers 3, 18 of the panel element. By the use of the wooden dowels 59, or wooden nails, a force-fit joint is achieved.

FIG. 11 shows a panel element 1 with a two-ply wooden cladding 55. Here a first ply 60 of boards 56 is attached by means of wooden dowels 59 to the respective outer layers 3, 18 of the panel element 1. At the same time the boards 56 of the first ply 60 have dovetail-shaped recesses and projections, which for their part enable a corresponding form-fit joint with boards 56 of a second ply 61 of the wooden cladding 55. The dovetail joints between the boards 56 of the first ply 61 and the boards 56 of the second ply 61 are formed in an analogous manner to the dovetail joints between the boards 2 of the layers 3, 4, 18, as described above with the aid of FIGS. 1 to 4.

With the aid of FIGS. 12 and 13 a beam 80 composed of a plurality of layers is described. In accordance with this example of embodiment the beam 80 is formed by means of three boards, which with their lengthwise directions oriented in parallel lie against one another and are joined together in a form-fit manner. To this end, connections are formed in the manner of dovetail joints between a first board 81 and a second board 82, on the one hand, and between the second board 82 and a third board 83 on the other. The boards 81, 82, 83 have in each case a sequence of dovetail-shaped recesses 84 and projections 85 following one another in the direction of their lengthwise extent. For their part, the recesses 84 and the projections 85 extend in the direction of a width 86 of the boards 81, 82, 83.

FIG. 13 shows the boards 81, 82, 83 of the beam 80 in their non-assembled state. As can be discerned with the aid of the illustration, the cross-section of the recesses 84 and projections 85 with respect to the direction of the width 86 is variable over the width 86. The cross-section of the projections 85 from a first edge 87 to an opposing second edge 88 is designed to vary in the form of a wedge. The projections 85 of the dovetail joints conveniently have on both sides an inclined position with a half wedge angle, with a value of between 0.5° and 10°, preferably of between 3° and 10°. Projections 85 of the first board 81 on the one hand, and recesses 84 of the second board 82 on the other, are thus shaped so as to be complementary to one another, and can be joined together in a manner that fills the space. The connection of the boards 81, 82, 83 to the beam 80 is significantly eased by the described inclined positions of the sides of the projections 85 and the sides of the recesses 84. The wedge-shaped configuration of the recesses 84 and projections 85, achieved by virtue of the inclined position, moreover also has the advantage that in the joining together process these can be pushed into one another up to a certain degree by means of an appropriate level of effort and thus additionally a force-fit effect is also achieved during the manufacture of the connection of the boards 81, 82, 83.

In an alternative form of embodiment, however, it would also be possible to provide an inclined position of the sides of the projections 85 and the recesses 84 on only one side. In accordance with further variants of embodiment a beam 80 composed of layers can also be composed of only two boards 81, 82; however, it can also be formed by more than three boards 81, 82, 83.

The examples of embodiment show possible variants of embodiment of the panel element 1, wherein at this point it is noted that the invention is not limited to these particularly illustrated embodiments but also diverse combinations of the individual variants of embodiment amongst themselves are possible and this possibility of variation on the basis of the technical information of the present invention lies within the capability of the skilled person active in this technical field. The scope of protection also comprises all conceivable variants which are possible by combining individual details of the variants described and illustrated.

For the record, it should finally be noted that for a better understanding of the construction of the panel member 1, the latter, or more particularly, its constituent parts, are on some occasions not drawn to scale, and/or are on some occasions enlarged and/or reduced in size.

The independent inventive solutions of the underlying task can be taken from the description.

Above all, the individual embodiments shown in FIGS. 1; 2; 3, 4; 5, 6; 7; 8; 9; 10; 11; 12 and 13 can form the subject matter of stand-alone inventive solutions. The relevant objects of the invention and solutions can be refered to in the detailed descriptions of these figures.

List of reference symbols

| | |
|---|---|
| 1 | Panel element |
| 2 | Board |
| 3 | Layer |
| 4 | Layer |
| 5 | Lengthwise axis |
| 6 | Board |
| 7 | Lengthwise axis |
| 8 | Board |
| 9 | Overlapping width |
| 10 | Width |
| 11 | Recess |
| 12 | Projection |
| 13 | Edge |
| 14 | Board centre |
| 15 | Half wedge angle |
| 16 | Gap |
| 17 | Centre plane |
| 18 | Layer |
| 19 | Thickness |
| 20 | Groove |
| 21 | Groove |
| 22 | Distance |
| 23 | Clear width |
| 24 | Width |
| 25 | Region |
| 26 | Region |
| 27 | Thickness |
| 28 | Depth |
| 41 | Beam |
| 42 | Thickness |
| 43 | Width |
| 44 | Recess |
| 45 | Depth |
| 46 | Side |
| 47 | Bolt |
| 48 | Groove |
| 49 | Beam |
| 55 | Wooden cladding |
| 56 | Board |
| 57 | Connecting element |
| 58 | Groove |
| 59 | Wooden dowel |
| 60 | Ply |
| 61 | Ply |
| 80 | Beam |
| 81 | Board |
| 82 | Board |
| 83 | Board |
| 84 | Recess |
| 85 | Projection |
| 86 | Width |
| 87 | Board edge |
| 88 | Board edge |
| 89 | Wedge angle |

1. Panel element (1) made of wood comprising at least two layers (3, 4) each of which is made of boards (2) lying adjacently to one another in a parallel manner, the boards (2) of a first layer (3) being aligned parallel with boards (2) of a second layer (4), and a board (2) of the first layer (3) and a board (2) of the second layer (4) being connected to each other by dovetail joints and the dovetail joints are produced by a sequence of dovetail-shaped recesses (11) and projections (12), said recesses (11) and projections (12) following one another in a direction of a longitudinal extension of the boards (2), wherein a board (2) of the first layer (3) and a board (2) of the second layer (4) are offset to each other in the direction of the width (10) and overlap each other and the recesses (11) of the dovetail joints have a wedge shape so as to taper from a board edge (13) to a board center (14).

2. Panel element (1) according to claim 1, wherein the recesses (11) of the dovetail joints have an inclined position on both sides, wherein the half wedge angle (15) of said inclined position has a value of between 0.5° and 10°.

3. Panel element (1) according to claim 1, wherein a board (2) of the first layer (3) and a board (2) of the second layer (4) overlap each other over an overlapping width (9) having a value that is equal to or greater than 10% of the board width (10).

4. Panel element (1) according to claim 1, wherein the dimensions of the projections (12) in proportion to the dimensions of the recesses (11) are such selected that boards (2) of one respective layer (3, 4, 18) lie against one another so as to be gap-free.

5. Panel element (1) according to claim 1, wherein the value of the overlapping width (9) corresponds to approximately one half of the width of the boards (2) and a tongue-and-groove-joint is designed between boards (2) lying adjacently to one another and within one layer (3, 4, 18).

6. Panel element (1) according to claim 1, wherein the projections (12) and the recesses (11) of the boards (2) are symmetric by reference to a center plane (17) vertical to the width (10) of the boards (2).

7. Panel element (1) according to claim 1, wherein the dimensions of the recess (11) is such calculated that a clear width (23) at the edge (13) of the board (2) equals a width (24) of the projection (12) in the region of the center plane (17).

8. Panel element (1) according to claim 1, wherein a beam (41) is arranged in a first end region with respect to a longitudinal axis (5) of the boards (2) and said beam (41) is aligned to be vertical with respect to the longitudinal axis (5) of the boards (2).

9. Panel element (1) according to claim 1, wherein the beam (41) is arranged so as to lie between the first layer (3) of boards (2) and a third layer (18) of boards (2).

10. Panel element (1) according to claim 1, wherein the beam (41) has a thickness (42) the value of which equals a value of a thickness (27) of the board (2).

11. Panel element (1) according to claim 1, wherein in a region distant from the two end regions a beam (49) is accommodated which is oriented to be parallel with the beam (41) disposed in the first end region and between the layers (3, 4, 18).

12. Panel element (1) according to claim 1, wherein the boards (2) and the beam (41) are fixed to one another by bolts (47) reaching through the boards (2) and the beam (41).

13. Panel element (1) according to claim 1, wherein depressions for the formation of cavities in the panel element (1) are formed into the projections (12) of the boards (2).

14. Panel element (1) according to claim 1, wherein grooves (48) are formed into the projections (12) of the boards (2).

15. Beam (80) made of wood comprising at least two boards (81, 82, 83) lying parallel to each other wherein a first board (81) and a second board (82) are connected to each other by dovetail joints and the dovetail joints are formed by a sequence of dovetail-shaped recesses (84) and projections (85), said recesses (84) and projections (85) following one another in a direction of a longitudinal extension of the boards (81, 82, 83), wherein the recesses (84) and the projections (85) extend toward a direction perpendicular to the longitudinal extension (86) of the boards (81, 82, 83), wherein the recesses (84) of the dovetail joints have a wedge shape so as to taper from a first board edge (87) to a second board edge (88).
